(19) United States
(12) Patent Application Publication
(10) Pub. No.: US 2009/0149152 A1
(43) Pub. Date: Jun. 11, 2009

(54) METHOD AND DEVICE FOR MAINTAINING AVERAGE POWER OF A BASEBAND SIGNAL

(75) Inventors: RONALD L. PORCO, FORT WORTH, TX (US); WARREN P. BERRYMAN, MANSFIELD, TX (US); WILLIAM C. GREENWOOD, TROPHY CLUB, TX (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/951,526

(22) Filed: Dec. 6, 2007

(51) Int. Cl. H04B 1/16

(52) U.S. Cl. 455/343.1

(57) ABSTRACT

A method and device maintains constant average power of a baseband signal. The baseband signal to be power amplified is received into a processing device that measures a first average power of the baseband signal. Peak reduction is performed on the received baseband signal. A second average power of the baseband signal is measured after peak reduction. Gain compensation is determined based on the difference between the first and second average power measurements. The gain compensation is applied to the baseband signal after the peak reduction in order to maintain a substantially constant average power of the baseband signal.

### TECHNICAL FIELD

The technical field relates generally to wireless communication systems and more particularly to gain compensation of a baseband signal post peak reduction.

### BACKGROUND

In modern wireless communication systems, mobile devices communicate with one another via base stations (BS). In general, a BS is infrastructure equipment that can receive data in a wireless signal from one or more mobile devices and transmit the data in wireless signals to one or more other mobile devices via communication links (also referred to herein as radio channels) with each of the mobile devices. Communication links comprise the physical wireless communication resources over which information is sent between the BS and each mobile device.

Wireless communication, thus, requires that the mobile devices and base stations have transmitter and receiver circuits (i.e., transceivers) for communicating the wireless signals. The transmitter circuits include amplifiers to amplify a signal before transmitting the signal to another device in the communication system. In particular, base stations typically use high power amplifiers to transmit wireless signals. These amplifiers can be very expensive and inefficient parts of the base stations, in part, because the power amplifiers are designed according to the maximum peak power that they have to handle. Accordingly, the power amplifiers can be made cheaper and more efficient by reducing the peak power of the signals that the power amplifier must amplify.

One way of reducing the peak power of a signal is by performing Crest Factor Reduction (CFR) of the signal. In a base station, CFR is performed on a baseband signal before sending the signal for power amplification. A baseband signal is a lower frequency signal prior to further processing, which translates the lower frequency baseband signal to a higher frequency radio frequency (RF) signal that can be sent over the communication link. The objective of CFR is to reduce the peak power of the signal down to a level such that the power amplifier efficiency is acceptable, and the waveform quality remains unaffected. However, CFR sometimes also results in reduction of average power of the signal.

In certain systems like Evolution-Data Optimized or Evolution-Data Only (EV-DO), in which the signals are Time Division Multiplexed (TDM) in nature, the peaks of the signal occur within well-defined logical channels within a time slot. Each of these channels usually has a different Peak to Average Ratio (PAR) (i.e., the ratio of the peak power to the average power) depending on the nature of the channel. When CFR is applied to such EV-DO signals, channels with higher peaks are clipped harder than those with relatively lower peaks. Consequently, the average power of the signal decreases with the increase in the clipping of the signal. Application of CFR to a baseband signal having varying PAR causes a variable change in the average power across the signal. In such instances, it sometimes becomes difficult for a mobile station to demodulate such a signal that has non-uniform average power across the signal. Also, such signals fail to meet the requirements of some of the communication standards (e.g. standards specifying requirements of EV-DO systems).

The conventional solution to these challenges is to reduce the amount of CFR performed, thereby decreasing the power capability of the transmitter. This approach, however, can have a significant adverse impact on cost, complexity, efficiency, and size of the power amplifiers.

Thus, there exists a need for a method and device for maintaining average power of a baseband signal, which addresses at least some of the shortcomings of past and present methods and devices.

### BRIEF DESCRIPTION OF THE FIGURES

The accompanying figures, where like reference numerals refer to identical or functionally similar elements throughout the separate views, which together with the detailed description below are incorporated in and form part of the specification and serve to further illustrate various embodiments of concepts that include the claimed invention, and to explain various principles and advantages of those embodiments.

FIG. 1 illustrates a wireless network including devices in accordance with some embodiments.

FIG. 2 illustrates a flowchart of a method for maintaining average power of a baseband signal in accordance with some embodiments.

FIG. 3 illustrates a base station in the system of FIG. 1 that maintains average power of a baseband signal in accordance with some embodiments.

FIG. 4 illustrates a baseband signal, in accordance with some embodiments, having a logical channel structure for transmitting on a forward link.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. Device and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, a method and device for maintaining average power of a baseband signal, while performing peak reduction of the baseband signal, is described hereafter. In a base station of a wireless network, the baseband signal, which is to be translated to RF and transmitted to a mobile station, is subjected to peak reduction. The peak reduction may lead to an uneven average power distribution in the resulting peak reduced signal. The method and device maintains a constant average power of the signal after it is subjected to peak reduction.

The device receives the input baseband signal and performs peak reduction. The baseband signal subjected to peak reduction has varying peak to average ratio. The device measures the change in average power before and after peak reduction and restores the average power to the original value. The change in the average power is determined by measuring a first average power of the baseband signal before peak reduction and a second average power of the baseband signal after peak reduction. Subsequently, gain compensation for the baseband signal is determined based upon the difference between the first average power measurement and the second average power measurement. Further, the gain compensation is applied to the baseband signal after peak reduction to match the average power of the baseband signal out of the peak reduction process with that of the baseband signal input into the peak reduction process. Thus, a constant average power of the baseband signal is maintained after peak reduction and before power amplification.

This results in efficient demodulation of the signal at the reception side in a mobile device. Maintaining constant average power of the baseband signal also results in compliance with some of the standards in wireless cellular networks (e.g. EV-DO standards). Those skilled in the art will realize that the above recognized advantages and other advantages described herein are merely illustrative and are not meant to be a complete rendering of all of the advantages of the various embodiments.

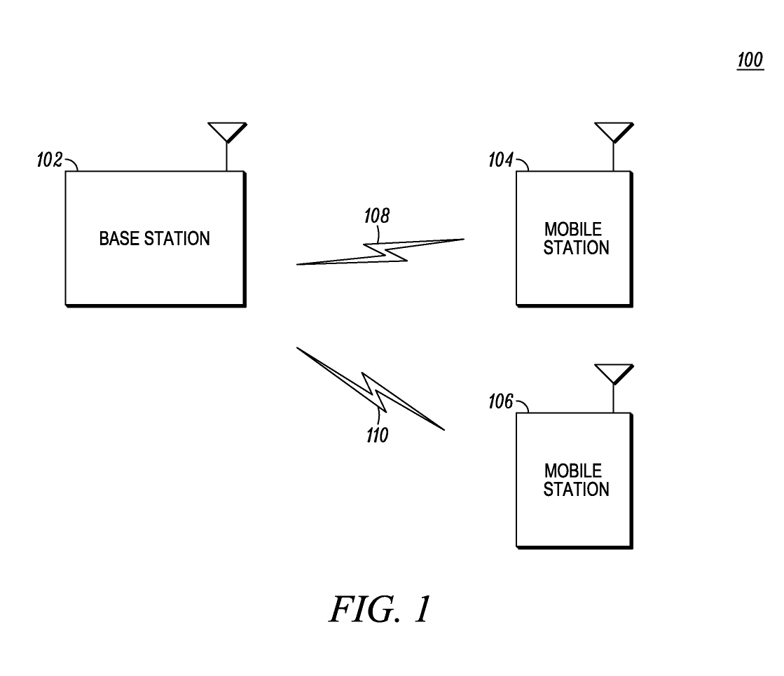

Referring now to the drawings, and in particular FIG. 1, a wireless network in accordance with some embodiments is shown and indicated generally at 100. Those skilled in the art, however, will recognize and appreciate that the specifics of this example are merely illustrative of some embodiments and that the teachings set forth herein are applicable in a variety of alternative settings. For example, since the teachings described do not depend on the wireless networks, they can be applied to any type of communication network, although a wireless network is shown in this embodiment. As such, other alternative implementations in different types of communication networks are contemplated and are within the scope of the various teachings described.

The wireless network 100 includes a Base Station (BS) 102, a Mobile Station (MS) 104 and another MS 106. As referred to herein, a BS includes, but is not limited to, equipment commonly referred to as base transceiver stations, site controllers, access points, or any other type of interfacing device in a wireless environment. As referred to herein, a MS includes, but is not limited to, devices commonly referred to as access terminals (AT), user equipment (UE), mobile devices, mobile subscriber units, or any other device capable of operating in a wireless environment. Examples of mobile stations include, but are not limited to, mobile phones, cellular phones, Personal Digital Assistants (PDAs), laptops and pagers. For purposes of clarity, the network 100 is shown with a single BS and two MS. However, a typical wireless network comprises additional such elements, which will be readily appreciated by one of ordinary skill in the art.

Moreover, a commercial embodiment of network 100 will likely comprise additional elements not shown in FIG. 1. For example, an embodiment of the wireless network 100 could be a cellular network. A typical cellular network includes a Public Switched Telephone Network (PSTN) (not shown in the figure), Mobile Switching Centers (MSCs) (not shown in the figure), BSs, and MSs. A BS is connected to a MSC which is further connected to the PSTN. A MS communicates with a BS in its range. The BS in turn, communicates with a MSC, which further communicates with the PSTN. A call that is initiated at a MS 104 is routed to a MSC via a BS 102 in the range of the MS 104. This call can be switched to another MS or MSC or PSTN depending on the destination of the call. The call is routed to the destination MS by the BS in the range of the destination MS.

In the wireless network 100, in accordance with some embodiments, a MS uses a temporary radio channel as a communication link to communicate with a BS, and the BS is capable of simultaneously communicating with more than one MS using one radio channel per MS. For example, the BS 102 communicates with the MS 104 using a radio channel 108 and communicates with the MS 106 using a radio channel 110. Each radio channel includes a forward link frequency for transmitting a signal to a MS and a reverse link frequency for receiving a signal from the MS. For instance, the BS may receive a communication signal from the MSC. The BS then processes the signal before transmitting it to a MS. The transmission section of a BS includes many operations that are usually performed during transmission of wireless signals, including baseband signal processing, power amplification, signal modulation, multiplexing, RF transmission, etc. In accordance with an embodiment, baseband signal processing includes performing peak reduction and maintaining constant average power of a baseband signal after peak reduction and is further explained in conjunction with subsequent figures.

In accordance with an embodiment, the wireless network 100 is a cellular network employing CDMA2000 standards, and more particularly Evolution-Data Optimized or Evolution-Data Only (EV-DO) standards. The EV-DO standards have undergone multiple revisions post its introduction in the 1xEV-DO standard document 3GPP2 C.S0024-A titled “CDMA2000 High Rate Packet Data Air Interface Specification”. Each of the revisions provided higher data rate capabilities in the EV-DO systems. In some of the later revisions, with the introduction of multiple carriers, the importance of maintaining the average power across an EV-DO signal increased.

Due to the TDM-nature of signals in systems employing EV-DO standards, the peaks of the signals occur within well-defined logical channels within a time slot. In accordance with an embodiment, the EV-DO signals are divided into a plurality of logical channels including, but not limited to, a Control/Traffic channel, a Media Access Control (MAC) channel, and a Pilot channel. According to an embodiment, Crest Factor Reduction (CFR) is used to perform peak reduction of the signals. Usually, the characteristics of the plurality of channels of the EV-DO signals are different from one another. As stated earlier, while applying CFR to an EV-DO signal, the logical channels with higher peaks are clipped harder than those with relatively lower peaks.

The presence of multiple carriers can also increase the peak power across the signal non-uniformly, resulting in a non-uniform average power distribution across the signal after CFR is applied. In the case of a single EV-DO carrier, the Control/Traffic channel is clipped the hardest, since it has the highest peak-to-average ratio (PAR). With the increase in the number of carriers, the average power of the Control/Traffic channel increases proportionately, but the PAR of the Control/Traffic channel remains the same due to the Gaussian nature of the Control/Traffic channel. In case of the Pilot channel, on addition of carriers, the average power of the Pilot channel increases proportionately. However, unlike the Control/Traffic channel, the PAR of the Pilot channel also increases with addition of carriers, due to high correlation between the Pilot channels of various carriers. Therefore, as the number of carriers increase, at certain multi-carrier configurations, the peaks of the Pilot channel exceed those of the Control/Traffic channel, and the Pilot channel is clipped harder than the Control/Traffic channel.

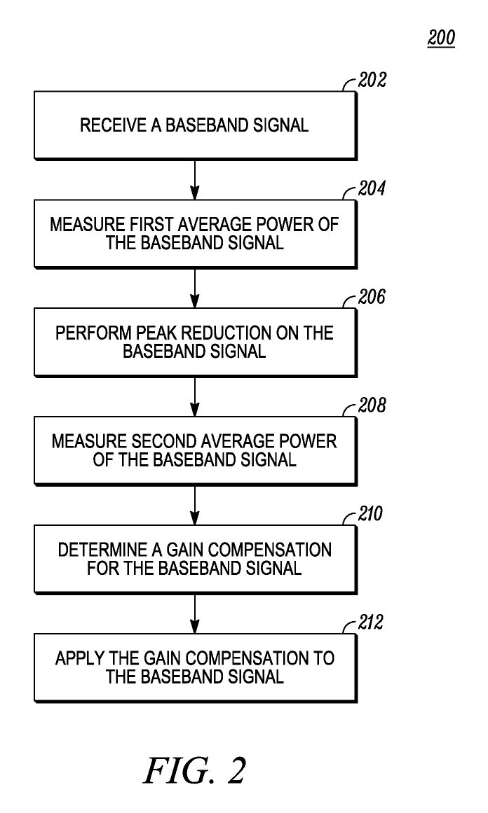

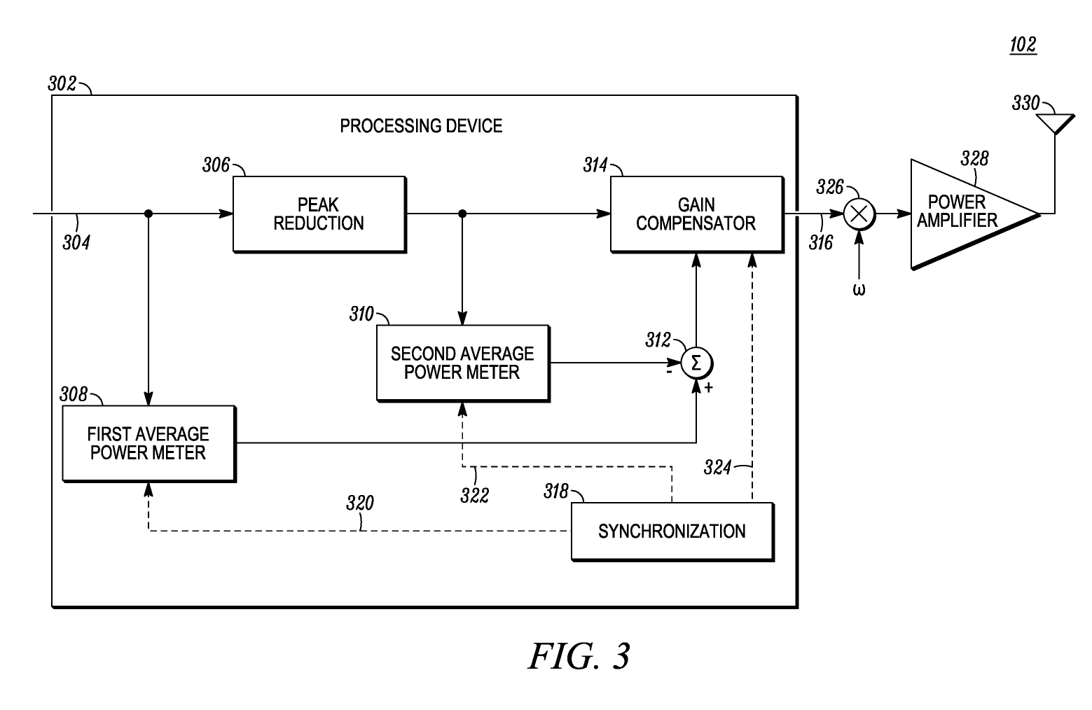

Accordingly, the CFR of a signal not only reduces the peak power of the signal but also the average power of the signal, and the drop in the average power of the signal is proportional to the amount of clipping of the signal occurring during the CFR. Thus, in an EV-DO configuration, since some channels get clipped harder than others during CFR, there can be a resultant variable average power across the signal from channel-to-channel post CFR. This can make it difficult for a MS to demodulate the signal and can result in a lower data rate or a total loss of the signal transmitted. Also, EV-DO standards 3GPP2 C.S0032-A require the average power of each channel to be nearly identical, or in other words substantially constant, to within the measurement error of the equipment being used for testing. The average power within a channel and between each of several (e.g., EV-DO) channels can be maintained after performing the peak reduction (e.g., CFR) using a method as described in conjunction with FIG. 2 and a device as described in conjunction with FIG. 3.

Turning now to FIG. 2, a method for maintaining constant average power of a baseband signal is shown and indicated generally at 200. In accordance with an embodiment, the BS 102 receives a baseband signal and processes the baseband signal before transmitting it to the MS 104. Processing of the baseband signal at the BS 102 includes peak reduction of the baseband signal and maintaining average power of the baseband signal after peak reduction in accordance with method 200. Subsequently, the baseband signal is provided to a mixer for frequency translation and a power amplifier for power amplification before transmission to the MS 104. Although the described embodiment depicts the BS 102 performing the method, the teachings herein are not limited to this particular implementation but can be applied to any device in a wireless network that applies peak reduction to a baseband signal and that must maintain substantially constant average power or a constant average power to within a measurement error, wherein substantially is further defined below.

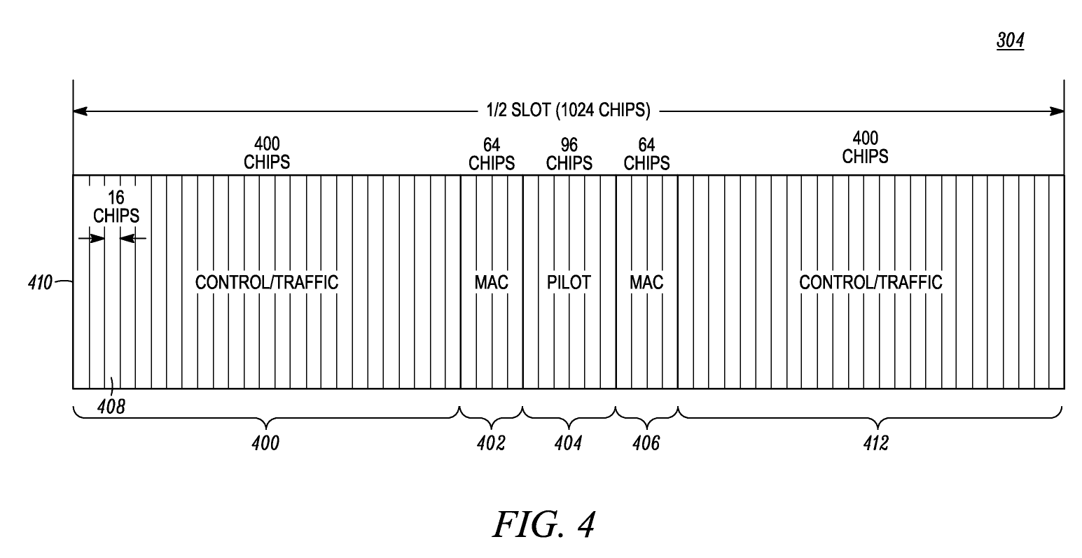

In general, method 200 includes: receiving (202) a baseband signal and performing peak reduction (206) on the baseband signal; measuring (204, 208) a first average power of the baseband signal before the peak reduction and a second average power of the baseband signal after the peak reduction; determining (210) a gain compensation for the baseband signal based on a difference between the first and second average power measurements; and applying (212) the gain compensation to the baseband signal after the peak reduction to maintain substantially constant average power of the baseband signal. In addition, in order to facilitate the method 200 being performed only within the boundaries of a given logical channel, a trigger point may be used to determine the beginning of a channel to coordinate measuring the first average power, measuring the second average power, determining the gain compensation and applying the gain compensation. A detailed illustrative implementation of method 200 is explained in conjunction with FIG. 3 and FIG. 4 in subsequent paragraphs.

Turning now to FIG. 3, an illustrative embodiment of the BS 102 having apparatus for maintaining substantially constant average power of a baseband signal in accordance with some embodiments is shown. As stated earlier, BS 102 has CDMA2000 capabilities and EV-DO capabilities so that it can operate in the EV-DO TDM system 100 described above. BS 102 includes a processing device 302 that receives a baseband signal 304 and further processes the baseband signal including performing peak reduction and maintaining average power of the baseband signal in accordance with the teachings herein. The baseband signal 304 is created using conventional circuitry in the BS 102, that is well known in the art, which performs functions including, but not limited to, encoding, modulation and multiplexing the signal prior to the peak reduction. The processed baseband signal 316 is supplied to a mixer 326 to convert the baseband signal 316 to RF, wherein the RF signal is amplified in a power amplifier 328 and transmitted via an antenna 330 to the MS 104. Details follow of the operation of the processing device 302 including its implementation of method 200 in accordance with this illustrative embodiment.

Processing device 302 may be implemented using any suitable processing device or combination of different types of processing devices including those described in subsequent paragraphs. The processing device 302 includes a peak reduction module 306, a first average power meter 308, a second average power meter 310, a summer 312, a gain compensator 314, and a synchronization module 318. In this embodiment, the peak reduction module 306 comprises a CFR module that may be implemented, for example, as a Field Programmable Gate Array (FGPA). The peak reduction module 306 receives the baseband signal 304 and performs the CFR process to limit any peaks in the signal above a predetermined threshold and may include techniques well known in the art for limiting adjacent frequent splatter resulting from the peak limiting function.

Turning momentarily to FIG. 4, an illustrative baseband signal in accordance with some embodiments is shown and indicated generally at 304. In an embodiment, the baseband signal 304, before being received into the processing device 302 (or at least received into this logical portion of the processing device 302 if other processing is also performed therein), is time divided into a plurality of logical channels, wherein each of the plurality of channels may have distinct characteristics in terms of PAR. Specifically in an EV-DO implementation, the forward link comprises slots of length 2048 chips, wherein each slot is further divided into two half slots of length 1024 chips as shown in FIG. 4 comprising the logical channels that each have a predefined length.

More particularly, each half-slot comprises a Control/Traffic channel 400 comprising 400 chips, a Medium Access Control (MAC) channel 402 comprising 64 chips, a Pilot channel 404 comprising 96 chips, another MAC channel 406 comprising 64 chips, and another Control/Traffic channel 412 comprising 400 chips. As can be seen, the logical channels each have first and second time boundaries based on a beginning (410) of the half/slot (which is also the beginning of the Control/Traffic channel 400) and based on the lengths of the channels, which defines the end boundary of one logical channel and the beginning boundary of the next logical channel.

Returning now to FIG. 3, the first average power meter 308 measures the average power of the baseband signal 304 before it is processed by the peak reduction module 306. The second average power meter 310 measures the average power of the baseband signal 304 after it is processed by the peak reduction module 306. The gain compensation value can be calculated directly as a ratio of the power meter measurements or as a difference if the power measurement values are expressed logarithmically. The latter approach is demonstrated in FIG. 3 as summer 312 calculates a difference between the measurements of the second average power meter and the first average power meter. The power difference determined by the summer 312 is provided to the gain compensator 314. The gain compensator 314 is coupled to the output of the peak reduction module 306 and determines a gain compensation value to compensate the peak reduced signal, based on the power difference determined at the summer 312, such that the average power of the output baseband signal 316 is maintained.

In accordance with this embodiment, gain compensation is separately determined 210 and applied 212 at least once within each of the plurality of channels of the baseband signal 304. The gain compensation can be determined 210 within a given channel by taking average power measurements 204 and 208 within a first and a second boundary of the channel and applying 212 the gain compensation within the first and second boundaries of the channel after performing 206 the peak reduction. In one implementation, the gain compensation is determined 210 and applied 212 a plurality of times within the first and second boundaries of at least one of the channels of the baseband signal by sampling the channel based on a sampling rate and measuring the first average power and second average power at each of the sampling instances. In an embodiment, it is desired that gain compensation compensate from 0.01 dB to 3 dB of post peak reduction average power loss, and for an EV-DO system that the gain compensation bring the post peak reduction average power value to within ±0.05 dB of the pre peak reduction average power value.

Since the EV-DO channels may have distinct PAR characteristics, it may be advantageous to determine 210 and apply 212 the gain compensation multiple times within each of the EV-DO channels. Moreover, accurate measurements are obtainable when the sampling is performed such that the first and second average power measurements are always taken within the same channel, i.e., does not cross channel boundaries. This can be achieved, for example, by choosing the sampling rate (in this case the sampling size) as a factor of each of the channel lengths. In an embodiment, the sampling size is determined to be the greatest common factor of the EV-DO channel lengths.

In accordance with an embodiment, the RF transceivers in the base station 102 include power amplifiers with average power measurements being performed at 61.44 MSPS. So that the sampling is not performed between two EV-DO channels, the width of a sample size 408 in the half slot (FIG. 4) of signal 304 can be set to 16 chips (a greatest common factor of 96, 64 and 400, which are respective widths of the Pilot channel 404, the MAC channels 402 and 406, and the Control/Traffic channels 400 and 412), and 800 signal samples taken within the 16 chips to generate the corresponding first and the second average power measurements and the gain compensation calculation. It should be noted that the number of samples taken within the time slice can be programmable to optimize the calculations. The gain compensation is determined 210 using a first average power measurement and a second average power measurement at each of these time slices. Accordingly, for the Pilot channel 404, the gain compensation is determined 210 in six consecutive calculations. Similarly, for each of the two halves of the MAC channel 402, 406, the gain compensation is determined 210 in four consecutive calculations, and for each of the two halves of the Control/Traffic channel 400, 412, the gain compensation is determined 210 in 25 consecutive calculations.

In another embodiment different sample sizes can be used for performing the average power measurement and/or gain compensation calculations depending on the logical channel being processed. For instance, a lesser number of samples can be used at any particular channel or just one average power measurement can be performed at the particular channel. Moreover in a further embodiment, for any given logical channel wherein the average power does not substantially change rapidly over time, an average power measurement from a previous time period (e.g., within the same or a different half slot) can be used for current gain compensation calculations.

For example, with respect to the slotting structure illustrated in FIG. 4, unlike the traffic channel, the pilot and MAC channels are always present and their power, therefore, does not substantially change from half-slot to half slot in a data only system. In a system with mixed data and voice, the power during the pilot and MAC channels may change due to changes in the voice traffic but this change is gradual. Therefore, one could, in one illustrative implementation, take an average power measurement on a complete MAC channel and use this value as the desired average power during the next MAC channel (both within the same half slot and in subsequent half slots). In a more specific illustrative implementation, one or more average power measurements are performed at MAC channel 402. The one or more average power measurements are then used to perform gain compensation at MAC channel 406. A similar scheme can be employed for gain compensation for Pilot channels. For the traffic channel, you can use an increased number of samples without a concern as to whether the sample size divides evenly into the width of the MAC and pilot channels.

To accurately perform the gain compensation, the average power measurement before and after the peak reduction process is synchronized by the synchronization module 318, and is further synchronized with the gain compensation so that the adjustment is made on the correct time slice. To accomplish this, synchronization module 318 provides a trigger point to set the average power measurements and gain compensation calculations to start at the beginning of a channel, e.g., at the start 410 of the control/traffic channel 400. However, the trigger can be set at the beginning of any channel. In one embodiment, the trigger point is based on a synchronization signal. For instance, in one implementation, a synchronization signal is included on a DO carrier signal for the baseband signal 304 and detected by the synchronization module 318. Upon detection of the synchronization signal on the DO carrier, the synchronization module 318 provides triggers, e.g., synchronization signals 320, 322 and 324, to the first average power meter 308, the second average power meter 310 and the gain compensator 314, respectively, so that each of the first and the second average power measurements and the gain compensation are coordinated to be performed on the correct time slice.

In accordance with another embodiment, the trigger point is determined based on a difference in average power between two consecutive average power measurements before the peak reduction, which exceeds a predetermined threshold. In a CDMA2000 system, for instance, the synchronization module 318 is configured such that it provides the trigger (e.g., synchronization signals 320, 322 and 324) when the average power between two consecutive sets of samples increases by more than 3 dB. This is because under the normal operating conditions in a CDMA2000 system, the average power is not expected to change by 3 dB rapidly, except at the start of data. As a result, an average power change of more than 3 dB between two consecutive sets of samples will set the trigger and provide an indication of the start of a data (e.g., Control/Traffic) channel.

In a DO only or a combined DO-CDMA2000 system, the synchronization module can be programmed to provide a trigger based on a transition from an idle Control/Traffic channel to a MAC channel. However, it should be noted that a comparative sample period (e.g., 25 samples) and a comparative amplitude variation (e.g., 3 dB), used to determine the sample size or period 408 and trigger point, can be programmable values ranging, for example, from 20 to 64000 for the comparative sample period and 0.1 dB to 13 dB for the comparative amplitude variation to optimize the system. The values can be chosen depending upon how accurately the average power is measured within the chosen number of samples and how quickly the average power transitions between channels in the digital realm.

The method and device described herein is not limited to EV-DO type of signals. It is also applicable in case of 4G technologies such as Worldwide Interoperability for Microwave Access (WiMAX) and 3GPP (Third Generation Partnership Project) Long Term Evolution (LTE). In the case of WiMAX signals, there are overhead channels having higher peaks than the data portions of the signals. Further, due to less stringent waveform quality requirements of the overhead signals, these peaks can be reduced harder than those of other signals. For such WiMAX signals that are TDM in nature, the peak reduction module 306 may be further configured for changing a clipping threshold from one time slot to another or from one logical channel to another. Those skilled in the art, however, will recognize and appreciate that although the clipping threshold for WiMAX signals may be adjustable, the average power of the WiMAX signals is maintained at a substantially constant value. A trigger provided by the synchronization module 318 can be used to define the clipping threshold for a particular time slot or logical channel. Further, the aforementioned flexibility of changing the clipping threshold is not limited to WiMAX signals but also applicable to other TDM-based interface technologies such as EV-DO or LTE.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and device for maintaining average power of a baseband signal described herein. The non-processor circuits may include, but are not limited to, a radio receiver, a radio transmitter, signal drivers, clock circuits, power source circuits, and user input devices. As such, these functions may be interpreted as steps of a method to perform the average power maintenance described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for maintaining average power of a baseband signal, the method comprising:
receiving a baseband signal and performing peak reduction on the baseband signal;
measuring a first average power of the baseband signal before the peak reduction and a second average power of the baseband signal after the peak reduction;
determining a gain compensation for the baseband signal based on a difference between the first and second average power measurements; and
applying the gain compensation to the baseband signal after the peak reduction to maintain substantially constant average power of the baseband signal.

2. The method of claim 1, wherein performing peak reduction on the baseband signal comprises using an adjustable clipping threshold for the peak reduction.

3. The method of claim 1, wherein the baseband signal comprises a plurality of channels each having first and second boundaries, and determining the gain compensation comprises determining a separate gain compensation for each channel.

4. The method of claim 3, wherein measuring the first average power and the second average power comprises:
for each channel, separately measuring the first average power and the second average power within the first and second boundaries of the channel to determine the corresponding gain compensation for the channel to maintain substantially constant average power within the channel.

5. The method of claim 4, wherein maintaining the substantially constant average power of the baseband signal comprises maintaining substantially a same constant average power over all of the plurality of channels.

6. The method of claim 4, wherein each of the plurality of channels comprises a length, and the method further comprising sampling the baseband signal at a sampling rate that is a factor of each of the lengths of the plurality of channels, such that for each channel the first average power and the second average power is measured within the first and second boundaries of the channel.

7. The method of claim 4 further comprising:
for at least one of the plurality of channels, measuring the first and the second average power a plurality of times to determine the gain compensation a corresponding plurality of times within the first and second boundaries of the channel for maintaining the substantially constant average power within the channel.

8. The method of claim 4, wherein:
for each channel, the first boundary is a beginning of the channel, and separately measuring the first average power and the second average power within the first and second boundaries of the channel comprises using a trigger point to determine the beginning of the channel.

9. The method of claim 8, wherein the trigger point is based on:
a synchronization signal; or
a difference in average power between two consecutive average power measurements before the peak reduction, wherein the difference exceeds a predetermined threshold.

10. The method of claim 3, wherein the plurality of channels comprises one of a pilot channel, Medium Access Control (MAC) channel, a control and traffic channel.

11. A device comprising:
a processing device:
receiving the baseband signal and performing peak reduction on the baseband signal;
measuring a first average power of the baseband signal before the peak reduction and a second average power of the baseband signal after the peak reduction;
determining a gain compensation for the baseband signal based on a difference between the first and second average power measurements; and
applying the gain compensation to the baseband signal after the peak reduction to maintain substantially constant average power of the baseband signal;
a mixer converting the baseband signal to a radio frequency signal after the gain compensation is applied;
an amplifier amplifying the radio frequency signal for transmission.

12. The device of claim 11, wherein the device operates in a Time Division Multiplexing (TDM) system.

13. The device of claim 12, wherein the TDM system comprises an Evolution-Data Optimized (EV-DO) system.

14. The device of claim 11, wherein the peak reduction comprises crest factor reduction (CFR).

15. The device of claim 11, wherein the device is a base station.

16. The device of claim 12, wherein the TDM system comprises a Worldwide Interoperability for Microwave Access (WiMAX) system.

17. The device of claim 12, wherein the TDM system comprises a Long Term Evolution (LTE) system.
